(19) United States
(12) Patent Application Publication
(10) Pub. No.: US 2024/0017958 A1
(43) Pub. Date: Jan. 18, 2024

(54) ERGONOMIC ADJUSTABLE INNER DIAMETER TURNTABLE FOR SIMPLIFYING CABLE PAYOFF

(71) Applicant: Sumitomo Electric Lightwave Corp., Raleigh, NC (US)

(72) Inventor: Daniel Brian Hangebrauck, N Topsail Beach, NC (US)

(21) Appl. No.: 18/372,959

(22) Filed: Sep. 26, 2023

Related U.S. Application Data
(60) Provisional application No. 62/410,030, filed on Oct. 19, 2016.

(51) Int. Cl. B65H 49/28; B65H 49/32

(52) U.S. Cl. CPC B65H 49/28; B65H 49/324; B65H 2701/34; B65H 2402/351

(57) ABSTRACT

A cable turntable device has a frame, a pan attached to the frame, a plate rotatably attached to the pan, arms pivotably attached to the plate, and a knob for controlling rotational movement of the plate relative to the pan. The plate has pivot points circumferentially around and at an outer circumferential edge of the plate. Each of the arms is attached to the plate at one of the pivot points. The knob is selectively rotatable to control relative rotation between the pan and the plate, which allows the arms to pivot, which in turn changes an inner diameter of the cable turntable device. The inner diameter is a same as, or greater than, a minimum acceptable bend diameter for a cable of a cable spool that the cable turntable device dispenses.

### CROSS-REFERENCE TO RELATED APPLICATION

This application claims priority to U.S. Patent Application Ser. No. 63/410,030, filed on Sep. 26, 2022, the disclosure of which is incorporated by reference herein in its entirety.

### BACKGROUND

With the ongoing rapid expansion of the Internet and the proliferation of Internet-connected devices (sometimes referred to as “smart” devices), the data transmission and computational demands imposed by this growth require ever-increasing IT infrastructure (e.g., datacenters, in which a multitude of server computers are installed, interconnected for data transmission, and cooled). Furthermore, the data transmission rates of connected devices are increasing rapidly, requiring higher data bandwidth transmission rates. Thus, even in existing datacenters, it is often required to install new data transmission cabling to enable higher data transmission rates. This is in addition to the requirement in newly-constructed datacenters in which the data transmission cables must be installed in order to provide interconnection between the server computers operating therein, as well as with the Internet.

Cables have typically been terminated (e.g., the terminal end installed on one or both ends of the cable) after installation of such cables within a datacenter. As noted hereinabove, there is at present a need to construct datacenters rapidly. Thus, in order to increase the speed of construction of datacenters for which the layout and/or construction may be well understood (e.g., the same or similar to existing datacenters), the use of pre-terminated cables can advantageously reduce cable installation time (e.g., the time that would be required to terminate each cable individually after installation of each such cable in the datacenter) by eliminating the termination step, as well as reduce traffic (e.g., installation and/or construction personnel) in the datacenter during construction as compared to when unterminated cables are being installed. However, the handling of these cables can be cumbersome without a device to simplify payout of pre-terminated cables from a cable spool. Cables are typically coiled or spooled to a size not significantly greater in size than they need to be for logistics purposes but great enough in size to avoid attenuation. Smaller diameter cables can be spooled (e.g., wound up) to have a smaller diameter than can larger cables. Larger diameter cables can and usually would be wound around a larger diameter to prevent breakage or attenuation. A need exists at present for a device that can be used interchangeably with spools of any suitable cable diameter (e.g., pre-terminated or unterminated) for rapid payout and installation within a datacenter.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

The following presents a summary to provide a basic understanding of one or more embodiments of the disclosure. This summary is not intended to identify key or critical elements, or to delineate any scope of particular embodiments or any scope of the claims. Its sole purpose is to present concepts in a simplified form as a prelude to the more detailed description that is presented later.

A cable turntable device comprises a frame, a pan attached to the frame, a plate rotatably attached to the pan, wherein the plate comprises a plurality of pivot points circumferentially around and at an outer circumferential edge of the plate, a plurality of arms pivotably attached to the plate, wherein each arm of the plurality of arms is attached to the plate at a corresponding one of the plurality of pivot points, and a knob that is rotatable between a locking position, in which the knob applies a compressive force that presses the plate against the pan to frictionally resist rotation of the plate relative to the pan, and an adjustment position, in which the compressive force is lessened or eliminated to allow the plate and the pan to rotate relative to each other, which allows the plurality of arms to pivot relative to the corresponding one of the plurality of pivot points on the plate. Rotating each arm of the plurality of arms relative to the corresponding one of the plurality of pivot points on the plate changes an inner diameter of the cable turntable device. The inner diameter is a same as, or greater than, a minimum acceptable bend diameter for a cable of a cable spool that the cable turntable device is configured to dispense.

A method of dispensing a cable from a cable spool comprises providing a cable turntable device comprising a frame, a pan attached to the frame, a plate rotatably attached to the pan, wherein the plate comprises a plurality of pivot points circumferentially around and at an outer circumferential edge of the plate, a plurality of arms pivotably attached to the plate, wherein each arm of the plurality of arms is attached to the plate at a corresponding one of the plurality of pivot points, and a knob that is rotatable between a locking position, in which the knob applies a compressive force that presses the plate against the pan to frictionally resist rotation of the plate relative to the pan, and an adjustment position, in which the compressive force is lessened or eliminated to allow the plate and the pan to rotate relative to each other, which allows the plurality of arms to pivot relative to the corresponding one of the plurality of pivot points on the plate. By rotating each arm relative to the plate, the cable turntable device can be used for installation of cable spools of any of a plurality of interior diameters and lengths. The method comprises rotating each arm of the plurality of arms relative to the corresponding one of the plurality of pivot points on the plate to change an inner diameter of the cable turntable device, providing the cable turntable device with the cable spool, the cable spool having an internal diameter that is a same as, or larger than, the inner diameter, and dispensing a cable from the cable spool, wherein the inner diameter is a same as, or greater than, a minimum acceptable bend diameter for the cable of the cable spool.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

FIG. 1 is an isometric view of an example embodiment of a cable turntable device, with the radial arms deployed in a fully extended position, such that the device is configured to accommodate a cable spool having a large diameter.

FIG. 2 is a top view of the cable turntable device in the configuration shown in FIG. 1.

FIG. 3 is an isometric view of the cable turntable device shown in FIGS. 1 and 2, with the radial arms deployed in an intermediate position, such that the device is configured to accommodate a cable spool having a diameter that is smaller than in the configuration shown in FIGS. 1 and 2.

FIG. 4 is a top view of the cable turntable device in the configuration shown in FIG. 3.

FIG. 5 is an isometric view of the cable turntable device shown in FIGS. 1-4, with the radial arms deployed in a fully retracted position, such that the device is configured to accommodate a cable spool having a diameter that is smaller than in the configurations shown in any of FIGS. 1-4.

FIG. 6 is a top view of the cable turntable device in the configuration shown in FIG. 5.

FIG. 7 is an isometric view of the cable turntable device shown in FIGS. 1-6, in which a cover is shown to contain the cable spool held within the cable turntable device.

FIG. 8 is an isometric view of the cable turntable device shown in FIGS. 1-7, in which a cable spool is installed within the cavity defined by the device for rapid payout of the cable.

FIG. 9 is an isometric view of a plurality of the cable turntable devices shown in FIG. 8 stacked sequentially on top of each other to form a cable turntable system.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

The terminology used herein is for the purpose of describing particular embodiments only and is not intended to be limiting of the presently disclosed subject matter.

While the following terms are believed to be well understood by one of ordinary skill in the art, the following definitions are set forth to facilitate explanation of the presently disclosed subject matter.

All technical and scientific terms used herein, unless otherwise defined herein, are intended to have the same meaning as commonly understood by one of ordinary skill in the art. References to techniques employed herein are intended to refer to the techniques as commonly understood in the art, including variations on those techniques or substitutions of equivalent techniques that would also be apparent to one of skill in the art. While the following terms are believed to be well understood by one of ordinary skill in the art, the following definitions are set forth to facilitate explanation of the presently disclosed subject matter.

In describing the presently disclosed subject matter, it should be understood that a number of techniques, features, steps, etc. are disclosed. Each of these has individual benefit and each can also be used in conjunction with one or more, or in some cases all, of the other disclosed techniques, features, steps, etc.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a vertical post” includes a plurality of such vertical posts, and so forth.

Unless otherwise indicated, all numbers expressing quantities of structures, features, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate for the disclosed devices, compositions, systems and/or methods.

The term “comprising,” which is synonymous with “including,” “containing,” and/or “characterized by,” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or feature not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising,” “consisting of,” and “consisting essentially of,” where one of these three terms is used herein, the presently disclosed and claimed subject matter can include the use of either of the other two terms.

As used herein, the term “and/or,” when used in the context of a listing of entities, refers to the entities being present singly or in any combination. Thus, for example, the phrase “A, B, C, and/or D” includes A, B, C, and D individually, but also includes any and all combinations and subcombinations of A, B, C, and D.

It will be understood that various details of the presently disclosed subject matter may be changed without departing from the scope of the presently disclosed subject matter. Furthermore, the foregoing description is for the purpose of illustration only, and not for the purpose of limitation.

The subject matter disclosed herein addresses problems encountered from the use of pre-terminated cables in the construction of IT infrastructure, such as datacenters. By using cable turntable devices and associated systems, example embodiments of which are disclosed herein, it is now possible to simplify payoff (e.g., dispensing, as from a roll, spool, coil, etc.) of cables, whether raw (i.e., unterminated) or pre-terminated, in the datacenter environment, which can lead to significant time savings to be realized by cabling installation technicians. Thus, using the cable turntable devices and systems disclosed herein, new datacenters or other cable-intensive IT infrastructure locations can be constructed much more rapidly than using conventional cabling installation devices and system, while also reducing construction costs associated with the installation of necessary cabling.

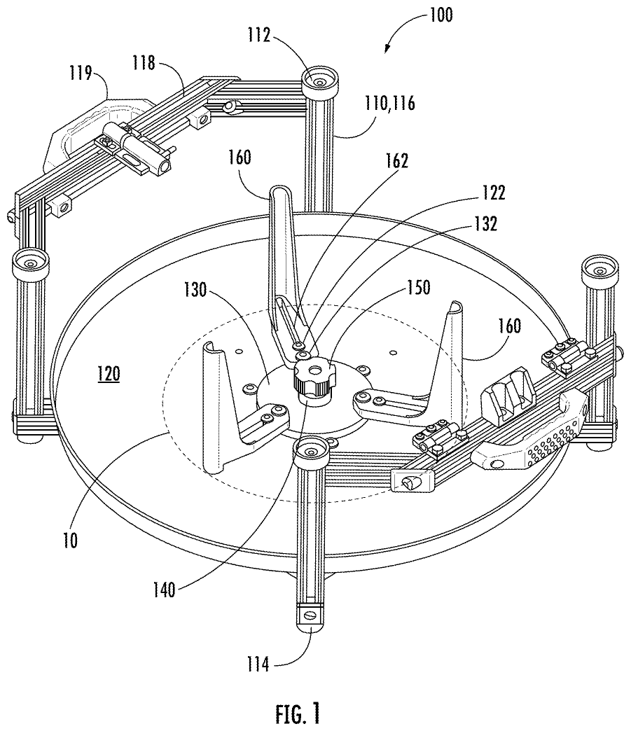

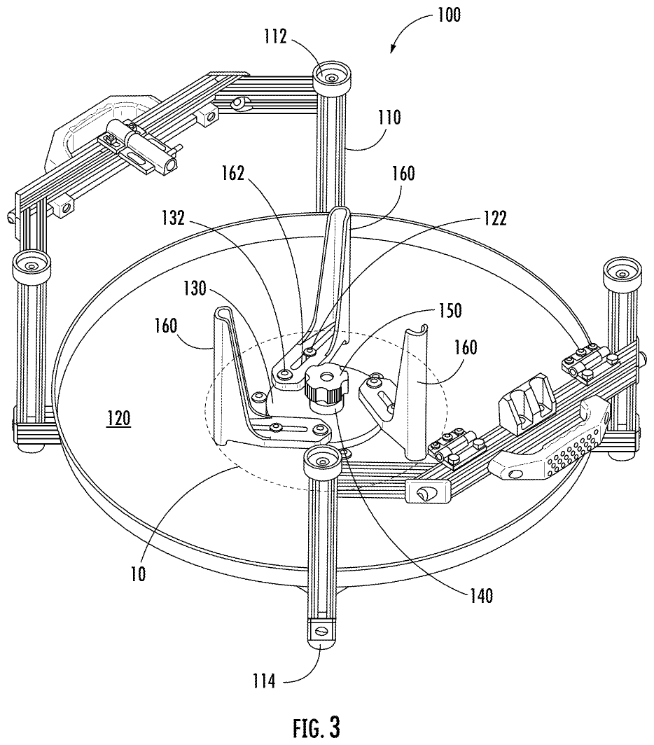

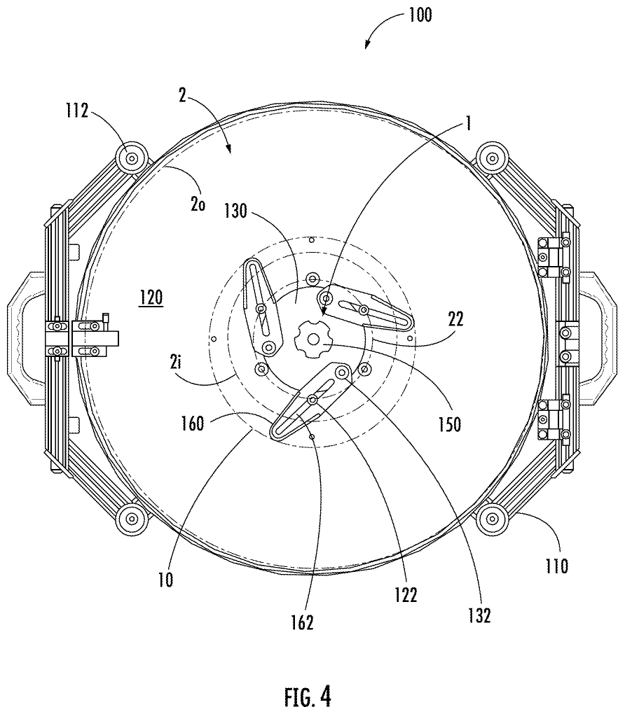

The subject matter disclosed herein relates to a device for rapid payout of cable from a cable spool during installation of such cable in a datacenter or similar environment. An example embodiment of this device is shown in FIGS. 1-8. This device is referred to herein as a cable turntable device and is generally designated in the figures with reference number 100. In the presently disclosed example embodiment, the cable turntable device 100 comprises or consists of a stackable frame 110, which has a plurality of receiver caps 112 attached to a top surface of the stackable frame 110 and a plurality of feet 114 attached to a bottom surface of the stackable frame 110. The top surface is on an opposite side of the stackable frame 110 from the bottom surface. The stackable frame 110 has, at the bottom surface thereof, a support area that extends across the diameter of the cable turntable device 100. In the example embodiment shown, the support area has a generally X-shaped structure. At each distal end of the sections that form the X-shaped structure, there is a generally vertically-extending vertical post 116. The receiver caps 112 and the feet 114 are positioned coaxial with each other, on opposing longitudinal ends of a plurality of the vertical posts 116.

Advantageously, the frame has, as shown in the example embodiment shown in FIGS. 1-8, at least four vertical posts 116, each vertical post 116 having a receiver cap 112 on a first end thereof, at or adjacent to (e.g., so as to define) the top surface of the stackable frame 110, and a foot 114 on a second end thereof, at or adjacent to (e.g., so as to define) the bottom surface of the stackable frame 110. Each receiver cap 112 is shaped to receive therein a corresponding foot 114. The vertical posts 116 and, therefore, the receiver caps 112 and the feet 114 are advantageously arranged mirrored across a midplane of the stackable frame 110. In some embodiments, the vertical posts 116 and, therefore, the receiver caps 112 and the feet 114 are evenly spaced apart from each other around the circumference of the cable turntable device 100. The stackable frame 110 also comprises an upper frame portion 118 extending between the vertical posts 116, attached to the vertical posts 116 adjacent to where the receiving caps 112 are attached to the vertical posts 116. A handle 119 is attached to at least two of the upper frame portions 118 to allow for the cable turntable device to be easily carried by hand by installation personnel. In the example embodiment shown in FIGS. 1-8, the stackable frame 110 only has four vertical posts 116 and, thus, only two upper frame portions 118. In some embodiments, the stackable frame 110 may have a same quantity of vertical posts 116 and upper frame portions 118, in which case each vertical post 116 is attached by an upper frame portion 118, on both sides, to circumferentially adjacent vertical posts 116.

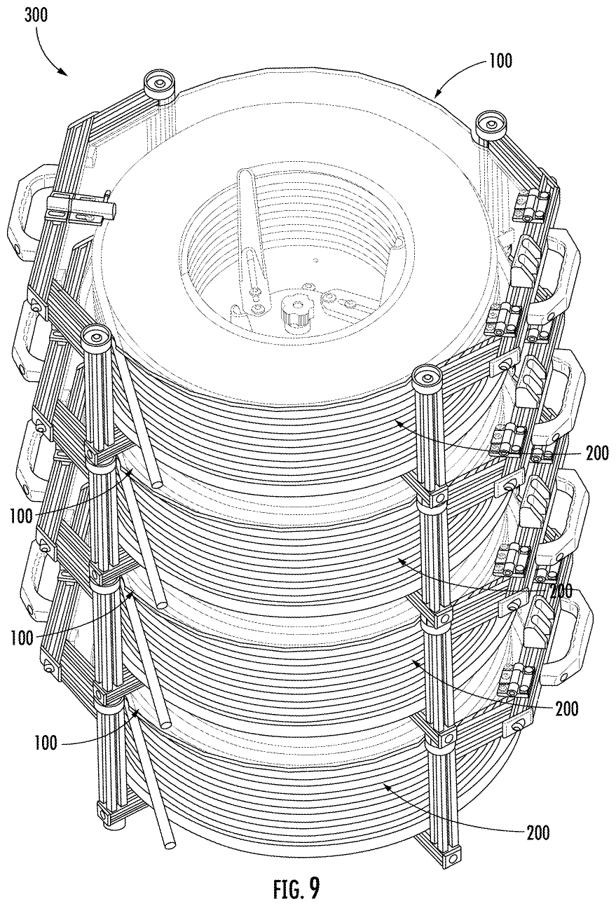

In some embodiments, the positioning of the vertical posts 116 and, therefore, the receiver caps 112 and the feet 114 is keyed, so that the cable turntable devices 100 can only be stacked on top of each other in a same orientation. By way of example, the keyed arrangement of the receiver caps 112 and the feet 114 can be used to ensure that the handles 119 attached on the opposing lateral sides of the stackable frame 110 are aligned with each other when multiple cable turntable devices 100 are stacked together, or otherwise attached to each other. Since each foot 114 is aligned with a corresponding receiver cap 112, a plurality of the cable turntable devices 100 can be stacked together by engagement of each foot 114 of one cable turntable device 100 within a respective one of the receiving caps 112 of a second cable turntable device 100, thereby allowing for stacking of multiple cable turntable devices 100 sequentially on top of one other to form a cable turntable system, generally designated 300, which is shown in FIG. 9.

Each cable turntable device 100 of the cable turntable system 300 can have a cable spool comprising a same or different type and/or size of cable. In some embodiments, each cable turntable device 100 of the cable turntable system 300 can have the same type and/or size of cable. In some embodiments, each cable turntable device 100 of the cable turntable system 300 can have a different type and/or size of cable. In some embodiments, more than one cable turntable device 100 of the cable turntable system 300 can have a first cable type and/or size and one or more (e.g., all) of the remaining cable turntable devices 100 of the cable turntable system 300 can have the same or different types and/or sizes of cable from each other and/or from the more than one cable turntable device 100. In short, the type and/or size of cable for each cable turntable device 100 can be any suitable cable and the types and/or sizes of cable can be selected for each cable turntable device 100 independent of the types and/or sizes of cable used in any of the other cable turntable devices 100 of the cable turntable system 300.

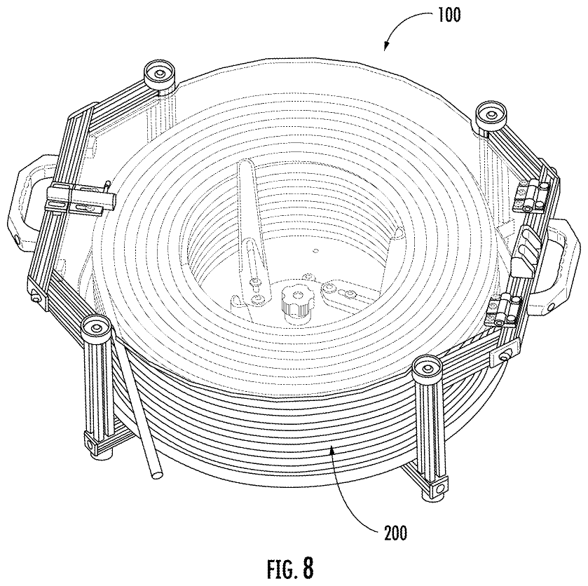

The cable turntable device 100 comprises a pan 120, which is attached to the stackable frame 110. The pan 120 is advantageously rotatably attached to the stackable frame 110 (e.g., on a bearing or bushing to provide for relative rotation between the stackable frame 110 and the pan 120). The pan 120 has a diameter that is substantially the same as a distance between opposing (i.e., diametrically opposing) vertical posts 116 of the stackable frame 110, such that the gap between each of the vertical posts 116 of the stackable frame 110 and the outermost circumferential edge, or rim, of the pan 120 is minimized. Preferable, the gap between each of the vertical posts 116 of the stackable frame 110 and the outermost circumferential edge of the pan 120 is less than a diameter of the cable that forms a cable spool (200, see FIG. 8) attached to the cable turntable device 100. The diameter of the pan 120 defines the cable capacity of the pan 120 with respect to the outer diameter of the cable spool 200 that be accommodated on the pan 200. In some embodiments, the diameter of the pan 120 is dictated by the dimensions of the stackable frame 110 itself, meaning that the largest diameter pan 120 that can possibly fit within the volumetric region bounded by the vertical posts 116 of the stackable frame 110 is advantageously selected for installation within a cable turntable device 100.

The cable turntable device 100 comprises, attached to the pan 120, a plate 130 that can rotate in unison with, or independent of, the pan 120. Thus, in some embodiments, the pan 120 may be fixedly attached (i.e., in an immobile manner) to the stackable frame, while the plate 130 is rotatable relative to the stackable frame 110. In such embodiments, the plate 130 is rotatably connected directly to the stackable frame 110, such as by a bearing or bushing being the only structure forming the rotatable connection between the plate 130 and the stackable frame 110. In some embodiments in which the pan 120 and the plate 130 are both rotatable relative to the stackable frame 110 and also to each other, there are several ways in which the respective rotatable connections can be made. In a first example, the pan 120 may be rotatably connected to the stackable frame 110, such as by a first bearing or bushing, and the plate 130 may be rotatably connected to the pan 120, such as by a second bearing or bushing. In a second example, the plate 130 may be rotatably connected to the stackable frame 110, such as by a first bearing or bushing, and the pan 120 may be rotatably connected to the plate 130, such as by a second bearing or bushing. In a third example, the pan 120 may be rotatably connected to the stackable frame 110, such as by a first bearing or bushing, and the plate 130 may also be rotatably connected to the stackable frame 110, such as by a second bearing or bushing, the attachment of the pan 120 to the stackable frame 110 being independent of the attachment of the plate 130 to the stackable frame 110, meaning that, for example, failure of the first bearing or bushing would not affect rotation of the plate 130 relative to the stackable frame 110 and, similarly, failure of the second bearing or bushing would not affect rotation of the pan 120 relative to the stackable frame 110. When cable is being unspooled from the cable turntable device 100, the pan 120 and the plate 130 advantageously co-rotate relative to the stackable frame 110, the rotation of the pan 120 and the plate 130 being in unison and at the same angular speed.

The cable turntable device 100 comprises a plurality of arms 160. Each of the arms 160 is pivotably attached to the plate 160. This pivoting movement of the arms 160 relative to the plate 130 is used to set an inner diameter 10 that is substantially the same as the internal diameter of a cable spool to be loaded into the cable turntable device 100. The pan 120 comprises a mechanism that allows for quick and easy adjustment of the inner diameter 10 by rotating the arms 160 about the pivot point 132. Each arm 160 pivots around a respective pivot point 132 in unison (e.g., simultaneously) with all of the other arms 160 to set the inner diameter 10 of the cable turntable device 100, such that the inner diameter 10 remains substantially circular. The inner diameter 10 is determined by the position of the arms 160. In the example embodiment shown, the arms 160 are attached to the plate 130 and the plate is, in turn, attached to the pan 120 by a knob 150 and a spacer 140. The spacer 140 and the knob 150 are used to selectively control relative rotational movement between the pan 120 and the plate 130. Thus, when the knob 150 is tightened (e.g., is threadably engaged to move in the axial direction towards the pan 120), the knob 150 exerts a force on the spacer 140 that, in turn, compresses the bottom surface of the plate 130 against the top surface of the pan 120 to frictionally lock the plate 130 and the pan 120 together, such that the pan 120 and the plate 130 will rotate together (e.g., in unison) relative to the stackable frame 110. In order to allow a rotational movement between the pan 120 and the plate 130, a user loosens (e.g., is threadably disengaged to move in the axial direction away from the pan 120) the knob 150 to reduce (e.g., partially or entirely) the compressive force exerted on the plate 130 by the spacer 140, thereby allowing the plate 130 to rotate concentrically with and relative to the pan 120. In some embodiments, the spacer 140 may be omitted entirely and/or formed in a unitary manner with the knob 150, such that the knob 150 can act directly on the plate 130 to exert the compressive force that presses the plate 130 against the pan 120.

Each arm 160 is pivotably attached to the plate 130 at a respective pivot point 132 and is pivotable about the respective pivot point 132. The proximal end of each arm 160 is fixedly attached to the plate 130 at the respective pivot point 132. The pivoting movement of each of the arms 160 about the respective pivot point 132 is controlled by a fixed attachment point 122 that is captively held in a mobile manner within a slot 162 formed in the arm 160. In each arm 160, the slot 162 extends from the proximal end of the arm 160 to the distal end of the arm 160. During the pivoting movement of each of the arms 160, a corresponding fixed attachment point 122 slides along the length of the slot 162 of the arm 160 with which the fixed attachment point 122 is associated. Since the fixed attachment point 122 can only move along the slot 162 of an arm 160 and the arm 160 is only pivotably attached to (e.g., is otherwise immobile relative to) the plate 130 at the pivot point 132, a relative rotary movement between the pan 120 and the plate 130 causes all of the arms 160 to simultaneously rotation around the respective pivot point 132 by which such arm 160 is connected to the plate 130. In the example embodiment shown, each arm 160 is connected to the plate 130 at a different pivot point 132.

Each fixed point 122 is attached to the pan 120 in a rigid and immobile manner, so as to be stationary relative to the pan 120. In the example embodiment shown, the slot 162 of each arm 160 is connected to only one of the fixed points 122 and, advantageously, each arm 160 is slidingly engaged with a different one of the fixed points 122. Thus, each fixed point 122 and slot 162 of an arm 160 engage together and are operable in the manner of a cam and slot. Since each of the arms 160 is pivotably attached to the plate 130 at a respective one of the pivot points 132 and is also slidably attached to the pan 120 at a respective one of the fixed points 122, the pivoting movement of one arm 160 causes a rotation of the plate 130 with respect to the pan 120 and, due to the substantially identical nature of the connection of each of the arms 160 to the plate 130, also causes a corresponding pivoting movement (e.g., in the same direction and of the same magnitude, as defined by an angular position thereof) of each of the other arms 160 about the plate 130 at the pivot point 132 associated therewith. Similarly, a rotation of the pan 120 relative to the plate 130 will also cause a substantially identical pivoting movement (e.g., in the same direction and of the same magnitude, as defined by an angular position thereof) of each of the arms 160 about the plate 130 at the pivot point 132 associated with each of the arms 160. Thus, when the knob 150 is loosened to allow for relative rotation between the plate 130 and the pan 120, pushing or pulling only one of the arms 160 (e.g., causing a movement in the clockwise or anticlockwise directions of only one arm 160 about the pivot point 132 by which such arm 160 is pivotably attached to the plate 130) will cause all of the other arms 160 to pivot about their respective pivot point 132 in unison with the arm 160 being pushed or pulled, thereby establishing a new inner diameter 10 for the cable turntable device 100 to allow a cable spool with a different internal diameter to be used with the cable turntable device 100. Similarly, when the knob 150 is loosened to allow for relative rotation between the plate 130 and the pan 120, rotating the pan 120 relative to the plate 130 will cause all of the arms 160 of the cable turntable device 100 to pivot about their respective pivot point 132 in unison with each other and with the rotation of the pan 120 relative to the plate 130.

In some embodiments, the fixed attachment points 122 may be tightened within the slots 162 of the arms to prevent pivoting movement of the arms 160 about the corresponding pivot point 132, either in lieu of or in addition to the compressive force exerted by the knob 150. However, in the example embodiments shown, the fixed attachment points 122 are inserted within the respective slots 162 of the arms 160 so as to always slide freely along the length of the slots 162, such that the knob 150 is the only way to control angular movement of the arms 160 to adjust the inner diameter 10 of the cable turntable device 100. Such a freely sliding engagement of the fixed attachment points 122 can be achieved by any suitable structure, as would be understood by persons having ordinary skill in the art. The use of the knob 150 solely to control movement of the arms 160 is advantageous because it is less likely to be damaged during use than, for example, using screws for the fixed attachment points 122 and screwing or unscrewing these screws to clamp or release, respectively, the arms 160 at the slots 162 thereof.

In some embodiments, the cable turntable device 100 can omit a pan 120, in which case the plate 130 can be rotatably attached to the stackable frame 110, much in the same way as the pan 120 is attached to the stackable frame 110, as described in greater detail elsewhere herein. In such embodiments in which the pan is omitted, the fixed attachment points 122 can, for example, be attached to the stackable frame 110.

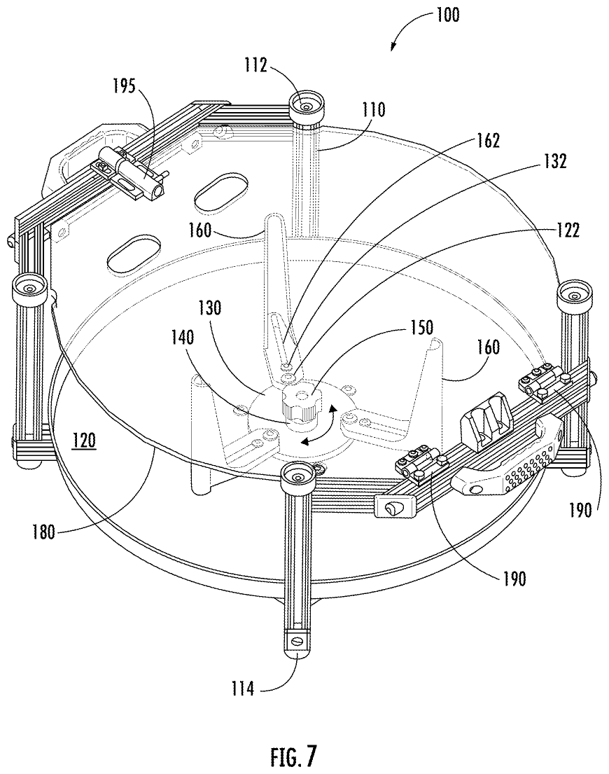

As best shown in FIGS. 7 and 8, the cable turntable device 100 can comprise, but does not necessarily require, a cover 180 that is pivotably attached to one of the upper frame portions 118 and the stackable frame 110 by hinges 190 attached, on one side of the hinge 190, on an edge of the cover 180 and, on an opposite side of the hinge 190, to the upper frame portion 118. The hinges 190 are advantageously attached to the same upper frame portion 118. The cover is lockable in a closed position, shown in FIGS. 7 and 8, via a lock 195. The lock 195 is connected, on one portion thereof, to the cover 180 and, on the other portion thereof, to another upper frame portion 118 from the upper frame portion 118 to which the hinges 190 are attached. In the example embodiment shown and described herein, the latch portion of the lock 195 is attached to the cover 180 and the catch portion of the lock 195 is attached to the upper frame portion 118. However, the lock 195 can also be attached in the opposite arrangement, in which case the latch portion of the lock 195 would be attached to the cover 180 and the catch portion of the lock 195 would be attached to the upper frame portion 118. Releasing the lock 195 allows the cover 180 to pivot about the hinges into the open position, which allows for a cable spool to be removed from and/or installed on the cable turntable device 100. The axes of the hinges 190, about which the cover pivots, are coaxial with each other. The top surface of the cover 180 is substantially coplanar with a plane defined by the upper surfaces of the upper frame portions 118, respectively.

At the distal end of each of the arms 160, there is a substantially vertically-extending arm portion that is attached to the substantially horizontally-extending base portion, in which the slot 162 is formed, such that each arm 160 has a cross-sectional shape that is generally in the shape of an “L”. The vertically-extending arm portion of each of the arms 160 is of sufficient height to form a sufficiently small gap between the cover 180 and the top end of the vertically-extending arm portion of the arm 160 (the top end being, for example, the point that is furthest from the base portion of the arm 160), so as to prevent any portion of the cable that forms the cable spool 200 from passing through this gap (e.g., between this top end of the arms 160 and the cover 180) while the cable is being dispensed (e.g., during payout) from the cable spool 200 installed in the cable turntable device 100. However, the vertically-extending arm portion of each of the arms 160 is such that the top end of the vertically-extending arm portion of each of the arms 160 is spaced apart from the inner surface of the cover 180 to prevent frictional drag of the arms 160 against the cover 180 during operation of the cable turntable device 100, which would hinder payout of the cable from the cable turntable device 100 and/or require application of a higher tension force on the cable to effect unwinding of the cable from the cable spool 200 during payout of the cable from the cable turntable device 100. The cover 180 also advantageously controls stacking of the coils of the cable spool 200 and resists the tendency of cable coils from “riding up” (e.g., in the direction of the cover 180) and passing over the top ends of the arms 160 as the cable is paid-out from the cable spool 200 installed on the cable turntable device 100.

The cable turntable device 100 has a central region, generally designated 1, and an outer region, generally designated 2. The central region 1 has a volumetric shape that is generally cylindrical. The outer region 2 has a volumetric shape that is generally annular, or ring-shaped; the outer region 2 can also be described as having a volumetric shape of a hollow cylinder. The central region 1 includes at least the plate 130, the arms 160, the pivot points 132, the fixed attachment points 122, the knob 150, and, when present, the spacer 140. The width (e.g., diameter) of the central region 1 is defined largely or entirely by the angular position of the arms 160, since the vertically-extending arm portions of the arms 160 are the components that extend radially the furthest distance away from the central vertical axis of the cable turntable device 100. The central vertical axis of the cable turntable device 100 is coaxial with the longitudinal axis of the knob 150. Thus, the volume occupied by the central region 1 and also the volume occupied by the outer region 2 is adjustable based on the angular position of the arms 160 with respect to the pivot points 132. While the total volume occupied by the central region 1 and the outer region 2, when considered together (i.e., by adding the respective volumes together), remains constant, the volume of the central region 1 is inversely proportional to the outer region 2, meaning that an increase in volume of the central region 1 causes a corresponding decrease (i.e., a decrease of the same magnitude) in the volume of the outer region 2. Correspondingly, a decrease in volume of the central region causes a corresponding increase (i.e., an increase of the same magnitude) in the volume of the outer region 2.

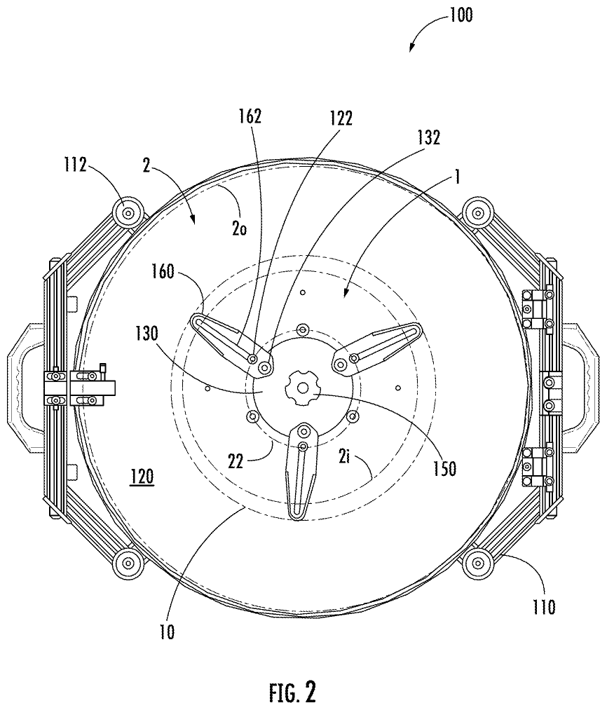

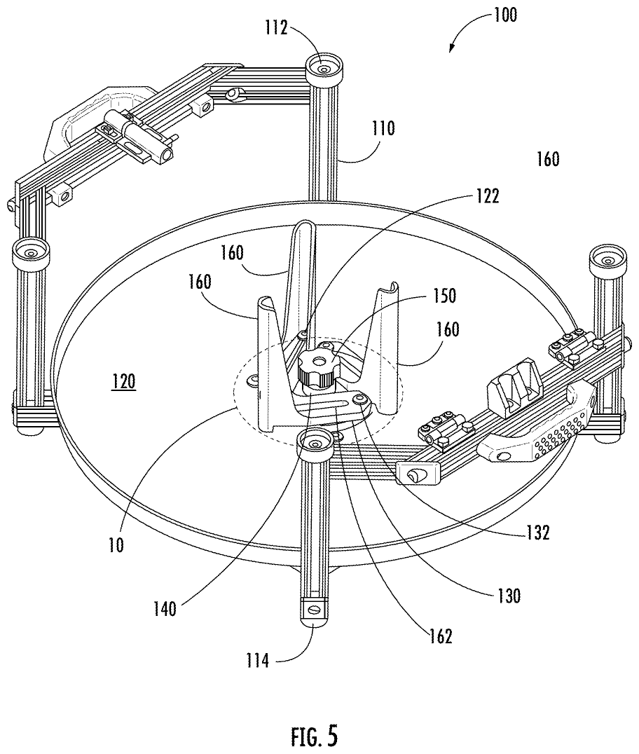

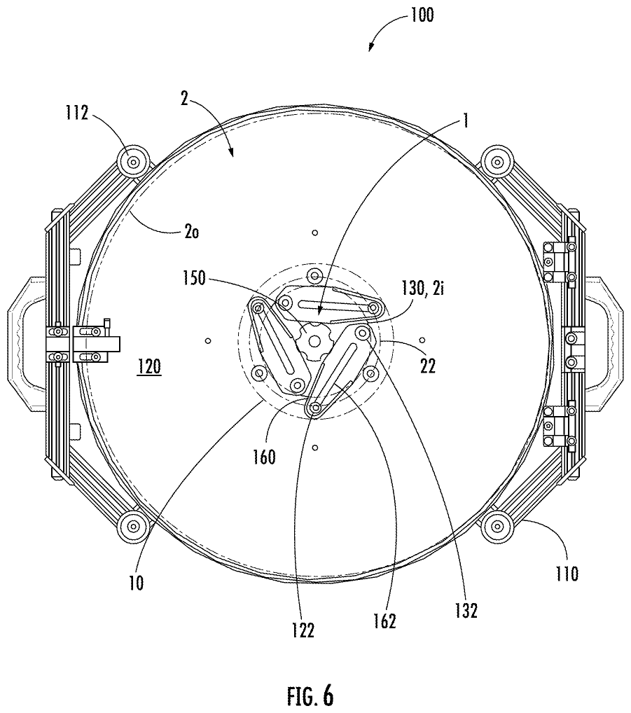

The central region 1 has the largest volume when the arms 160 are in the fully extended position shown in FIGS. 1 and 2, in which each of the arms 160 extends substantially radially away from the central vertical axis of the cable turntable device 100. Correspondingly, the outer region 2 has the smallest volume when the arms 160 are in the fully extended position shown in FIGS. 1 and 2. In the fully extended position, each fixed attachment point 122 is located in a proximal end of the slot 162 of one of the arms 160, the proximal end being the end of the slot 162 closest to the pivot point 132 attached to the same arm 160. The central region 2 has the smallest volume when the arms are in the fully retracted position shown in FIGS. 5 and 6, in which each of the arms 160 is fully angularly deflected, or pivoted, relative to the pivot point 132 by which such arm 160 is attached to the plate 130. Correspondingly, the outer region 2 has the largest volume when the arms 160 are in the fully retracted position shown in FIGS. 5 and 6. In the fully retracted position, each fixed attachment point 122 is located in a distal end of the slot 162 of a corresponding one of the arms 160, the distal end being the end of the slot 162 furthest away from the pivot point 132 attached to the same arm 160. A partially retracted position of the arms 160 is shown in FIGS. 5 and 6.

In the example embodiment shown, the arms 160 pivot about the pivot points 132 in a clockwise direction, however, in some embodiments the arms 160 may pivot about the pivot points 132 in an anticlockwise direction. In some embodiments, the arms 160 may be configured to pivot about the pivot points 132 in either the clockwise direction or the anticlockwise direction. The cable turntable device 100 is configured such that the inner diameter 10 defined by the angular position of each of the arms 160 can quickly and easily be adjusted to accommodate cable spools 200 having any of a wide variety of internal diameters, which can be formed out of a cable having any desired cable diameter, from small to large, that may typically be installed in a datacenter. According to an advantageous aspect, the presently disclosed cable turntable device 100 is designed to maximize the usable volume in the outer region 2 by adjusting the arms 160 and, accordingly, the volume of the central region 1 based to substantially match the internal diameter of the cable spool 200 that is to be installed in the cable turntable device 100 for storage and/or handling of the terminations (e.g., connectors, which can be large and bulky). Thus, the cable turntable device 100 can be readily adjusted to minimize the volume of the central region 1 to maximize the volumetric area available for accommodating the cable spool 200 therein. This maximization of the volume within the outer region is due, at least in part, to the design of the arms 160 and the plate 130, such that substantially the entire volume (e.g., excluding the volumetric region occupied by the spacer 140, knob 150, and plate 130) radially within the vertically-extending arm portions of the arms 160 is substantially vacant, or empty, and, as such, available for having terminations of cables (i.e., plugs or other suitable cable ends) positioned within the central region 1. By maximizing the usable volume in the outer region 2, the length and/or capacity of the cable that can be wound around the arms 160 within the radial confines of the stackable frame 110 is maximized in the presently disclosed cable turntable device 100, while maintaining a footprint for the cable turntable devices 100 that maintains an acceptable degree of maneuverability and/or portability by and/or for installation personnel. Furthermore, since fiber optic cables inherently have a minimum acceptable bend radius that will prevent (1) breakage and/or damage to the fiber contained within the cable fiber breaks and/or (2) attenuation problems, the angular position of the arms 160 may be adjusted such that the diameter of the central region 1 substantially matches (e.g., is the same as) the minimum acceptable bend radius of the cable for the cable spool 200. The terms minimum acceptable bend radius and minimum acceptable bend diameter can be used interchangeably, with the minimum acceptable bend diameter being double the minimum acceptable bind radius, since the diameter of a circle is double the radius of the circle. Additionally, since the central region 1 is largely an empty volumetric area, the central region 1 is an advantageous location for storage of jumper/termination (e.g., cable terminations) without increasing the size of the cable turntable device 100 to allow for storage of such components. The central region 1 is, before storage of cable termination devices therein, at least 50% empty, at least 75% empty, and/or at least 90% empty.

The cable turntable devices 100 are, as noted elsewhere herein, provided with a plurality of receiver caps 112 and a plurality of feet 114 that are each respectively rigidly attached to the stackable frame 110. As shown in FIGS. 1-8, there is one receiver cap 112 rigidly attached to the top of each of the vertical posts 116 of the stackable frame 110 and there is also one foot 114 rigidly attached to the bottom of each of the vertical posts 116 of the stackable frame 110. Thus, to allow for sequential stacking of a plurality of cable turntable devices 100 one on top of the next to form a cable turntable system 300, each foot 114 of the cable turntable system 300 is substantially (e.g., entirely) coaxial with a corresponding one of the receiver caps 112, which is vertically above (e.g., directly) each such foot 114. As such, during a stacking operation to form such the cable turntable system 300, each subsequent cable turntable device 100 being stacked on top of a previously positioned cable turntable device 100 is aligned with the previously positioned cable turntable device 100 so that each foot 114 of the subsequent cable turntable device 100 aligns with and is inserted within, or received within, a corresponding one of the receiver caps 112 of the previously positioned cable turntable device 100.

In some embodiments, the arrangement of the receiver caps 112 and the feet 114 (e.g., and, necessarily of the vertical posts 116 of the stackable frame 110 that correspond thereto) can be uniformly arranged to allow for the sequential stacking of a plurality of cable turntable devices 100 without regard to the orientation of any of the cable turntable devices 100 in the cable turntable system 300. In some embodiments, however, the arrangement of the receiver caps 112 and the feet 114 (e.g., and, necessarily of the vertical posts 116 of the stackable frame 110 that correspond thereto) can be keyed, or non-uniform, so that the subsequent cable turntable device 100 can only be stacked on top of the previously positioned cable turntable device 100 to form at least a portion of a cable turntable system 300 in a prescribed orientation. In the cable turntable system 300, the cable turntable devices 100 are constructed for secure stacking and/or nesting on top of each other in a sequential manner to allow for multiple cables (e.g., one cable from each of the cable turntable devices 100 of the cable turntable system 300) to be paid out (e.g., dispensed) for installation at the same time (e.g., simultaneously) to further maximize time savings associated with cable installation using the cable turntable devices 100 and cable turntable systems 300 disclosed herein. Through the use of a plurality of stacked cable turntable devices 100 in the cable turntable system 300, payoff (e.g., dispensing) of a wide variety of cables (e.g., of any of a plurality of diameters and/or lengths, whether raw or terminated) simultaneously or separately is greatly simplified, allowing for a significant time and cost savings to be realized in construction of a datacenter. Furthermore, by vertically stacking together the cable turntable devices 100 of the cable turntable system 300, the amount of floor space that needs to be occupied by the cable turntable system 300 for installation of multiple cables simultaneously is reduced as compared to if the cable turntable devices 100 were not stackable; thus, floor space within the datacenter that might otherwise be occupied is left unoccupied so as to not restrict movement of installation personnel and/or hardware in aisles and/or other distribution areas.

Because the inner diameter 10 of the cable turntable devices 100 disclosed herein is quickly and easily adjustable to accommodate cable spools 200 of different internal diameters, while at the same time being able to accommodate terminations associated with a plurality of different cables that may be installed in a datacenter or other IT infrastructure location, such cables ranging from small to large diameters, the cable turntable devices 100 and cable turntable systems 300 disclosed herein enable quick payoff and installation of a plurality of cables, whether the same as or different from each other, into the datacenter. Cables with smaller diameters can be spooled, or wound up, to produce cable spools with smaller interior diameters than is possible for cable spools produced from cables with larger diameters, which typically require a correspondingly larger internal diameter. Thus, each cable turntable device 100 can have the arms 160 thereof adjusted so that each cable turntable device 100 has an inner diameter 10 that is substantially the same as the cable spool 200 to be installed thereon. Cable spools 200 formed from smaller-diameter cables typically require less space for terminations, which is advantageous for accommodation of terminations within the central region 1 of the cable turntable device 100. Cables with comparatively larger diameters are typically wound to form a cable spool 200 with a larger internal diameter to prevent breakage and/or attenuation of the cable that could happen if the internal diameter of the cable spool 200 is less than the minimum acceptable bend radius for the cable. By adjusting the arms 160 of the cable turntable devices 100 disclosed herein to increase the inner diameter, the volume of the central region 1 of the cable turntable device 100 is correspondingly increased, which is often needed for accommodating terminations for comparatively large diameter cables. Storing cable terminations in the central region 1 defined by the adjustment of the central region of the cable turntable device 100 is advantageous in ensuring that such cable terminations do not become entangled with the cable itself during payoff of the cable from the cable turntable device 100.

The present subject matter can be embodied in other forms without departure from the spirit and essential characteristics thereof. The embodiments described therefore are to be considered in all respects as illustrative and not restrictive. Although the present subject matter has been described in terms of certain preferred embodiments, other embodiments that are apparent to those of ordinary skill in the art are also within the scope of the present subject matter.

1. A cable turntable device comprising:
a frame;
a pan attached to the frame;
a plate rotatably attached to the pan, wherein the plate comprises a plurality of pivot points circumferentially around and at an outer circumferential edge of the plate;
a plurality of arms pivotably attached to the plate, wherein each arm of the plurality of arms is attached to the plate at a corresponding one of the plurality of pivot points; and
a knob that is rotatable between a locking position, in which the knob applies a compressive force that presses the plate against the pan to frictionally resist rotation of the plate relative to the pan, and an adjustment position, in which the compressive force is lessened or eliminated to allow the plate and the pan to rotate relative to each other, which allows the plurality of arms to pivot relative to the corresponding one of the plurality of pivot points on the plate;
wherein rotating each arm of the plurality of arms relative to the corresponding one of the plurality of pivot points on the plate changes an inner diameter of the cable turntable device; and
wherein the inner diameter is a same as, or greater than, a minimum acceptable bend diameter for a cable of a cable spool that the cable turntable device is configured to dispense.

2. The cable turntable device of claim 1, wherein:
the pan comprises a plurality of fixed points rigidly attached thereto;
each of the plurality of arms comprises a slot; and
the slot of each of the plurality of arms is configured to hold in a captive manner a corresponding one of the plurality of fixed points, so that the corresponding one of the plurality of fixed points can slide along a length of the slot, such that a pivoting movement of each of the arms is controlled in a manner of a cam and slider, or follower.

3. The cable turntable device of claim 2, wherein the plurality of arms pivot simultaneously with each other to change the inner diameter of the cable turntable device, the inner diameter being a same as, or smaller than, the interior diameter of the cable spool designated for payoff from the cable turntable device.

4. The cable turntable device of claim 3, wherein each of the plurality of arms has an L-shaped cross-section with a base portion, in which the slot is formed, and a vertically-extending arm portion, wherein, for each of the plurality of arms, a surface of the vertically-extending arm portion that is furthest radially from a central vertical axis of the cable turntable device defines, together, the inner diameter of the cable turntable device.

5. The cable turntable device of claim 4, comprising a central region defined radially inwardly of the vertically-extending arm portion of each of the plurality of arms, wherein the central region is substantially vacant to allow for storage therein of cable terminations for the cable of the cable spool.

6. The cable turntable device of claim 4, comprising a cover attached to the frame at an upper surface of the frame and spaced apart from an upper surface of the pan by at least a vertical height of the vertically-extending arm portion of each of the plurality of arms, such that a distal end of the vertically-extending arm portion of each of the plurality of arms is adjacent to an inner surface of the cover to prevent passage of any of the cable of the cable spool from passing between the inner surface of the cover and the distal end of the vertically-extending arm portion of each of the plurality of arms, wherein the distal end of the vertically-extending arm portion of each of the plurality of arms is a point furthest away from where the vertically-extending arm portion is connected to the base portion of a same arm of the plurality of arms, and wherein the inner surface of the cover faces the upper surface of the pan when the cover is in a closed position.

7. The cable turntable device of claim 1, wherein the pan has an outer diameter that is a same as, or smaller than, a distance between diametrically opposing vertical posts of the frame, such that there is a gap between an outermost circumferential edge of the pan and the vertical posts of the frame, the gap being smaller than an outer diameter of the cable of the cable spool to prevent any of the cable of the cable spool from passing through the gap.

8. The cable turntable device of claim 1, comprising a plurality of feet rigidly attached to a bottom surface of the frame and a plurality of receiver caps rigidly attached to a top surface of the frame, wherein each of the plurality of feet is positioned vertically coaxial with a corresponding one of the plurality of receiver caps, such that the cable turntable device is configured for vertical stacking on top of a first cable turntable device and, furthermore, such that the cable turntable device is configured for having a second cable turntable device vertically stacked on top of the cable turntable device.

9. The cable turntable device of claim 1, wherein the pan is rotatably attached to the frame and/or the plate is coaxial with the pan.

10. A cable turntable system comprising a plurality of cable turntable devices, wherein two or more cable turntable devices of the plurality of cable turntable devices are the cable turntable device according to claim 1, wherein the two or more cable turntable devices are stacked sequentially on top of each other, and wherein the cable turntable system is configured for multiple cables to be dispensed simultaneously from the cable turntable system, each cable of the multiple cables being dispensed from a different one of the plurality of cable turntable devices.

11. The cable turntable system of claim 10, wherein the multiple cables have a same or a different diameter from each other.

12. A method of dispensing a cable from a cable spool, the method comprising:
providing a cable turntable device comprising:
a frame;
a pan attached to the frame;
a plate rotatably attached to the pan, wherein the plate comprises a plurality of pivot points circumferentially around and at an outer circumferential edge of the plate;
a plurality of arms pivotably attached to the plate, wherein each arm of the plurality of arms is attached to the plate at a corresponding one of the plurality of pivot points; and
a knob that is rotatable between a locking position, in which the knob applies a compressive force that presses the plate against the pan to frictionally resist rotation of the plate relative to the pan, and an adjustment position, in which the compressive force is lessened or eliminated to allow the plate and the pan to rotate relative to each other, which allows the plurality of arms to pivot relative to the corresponding one of the plurality of pivot points on the plate;
wherein, by rotating each arm relative to the plate, the cable turntable device can be used for installation of cable spools of any of a plurality of interior diameters and lengths;
rotating each arm of the plurality of arms relative to the corresponding one of the plurality of pivot points on the plate to change an inner diameter of the cable turntable device;
providing the cable turntable device with the cable spool, the cable spool having an internal diameter that is a same as, or larger than, the inner diameter; and
dispensing a cable from the cable spool;
wherein the inner diameter is a same as, or greater than, a minimum acceptable bend diameter for the cable of the cable spool.

13. The method of claim 12, wherein:
the pan comprises a plurality of fixed points rigidly attached thereto;
each of the plurality of arms comprises a slot; and
the slot of each of the plurality of arms holds in a captive manner a corresponding one of the plurality of fixed points, so that the corresponding one of the plurality of fixed points can slide along a length of the slot, such that a pivoting movement of each of the arms is controlled in a manner of a cam and slider, or follower.

14. The method of claim 13, wherein the plurality of arms pivot simultaneously with each other to change the inner diameter of the cable turntable device, the inner diameter being a same as, or smaller than, the interior diameter of the cable spool designated for payoff from the cable turntable device.

15. The method of claim 14, wherein each of the plurality of arms has an L-shaped cross-section with a base portion, in which the slot is formed, and a vertically-extending arm portion, wherein, for each of the plurality of arms, a surface of the vertically-extending arm portion that is furthest radially from a central vertical axis of the cable turntable device defines, together, the inner diameter of the cable turntable device.

16. The method of claim 15, comprising a central region defined radially inwardly of the vertically-extending arm portion of each of the plurality of arms, wherein the central region is substantially vacant to allow for storage therein of cable terminations for the cable of the cable spool.

17. The method of claim 15, comprising attaching a cover to the frame at an upper surface of the frame and spaced apart from an upper surface of the pan by at least a vertical height of the vertically-extending arm portion of each of the plurality of arms, such that a distal end of the vertically-extending arm portion of each of the plurality of arms is adjacent to an inner surface of the cover to prevent passage of any of the cable of the cable spool from passing between the inner surface of the cover and the distal end of the vertically-extending arm portion of each of the plurality of arms, wherein the distal end of the vertically-extending arm portion of each of the plurality of arms is a point furthest away from where the vertically-extending arm portion is connected to the base portion of a same arm of the plurality of arms, and wherein the inner surface of the cover faces the upper surface of the pan when the cover is in a closed position.

18. The method of claim 12, wherein the pan has an outer diameter that is a same as, or smaller than, a distance between diametrically opposing vertical posts of the frame, such that there is a gap between an outermost circumferential edge of the pan and the vertical posts of the frame, the gap being smaller than an outer diameter of the cable of the cable spool to prevent any of the cable of the cable spool from passing through the gap.

19. The method of claim 12, comprising:
rigidly attaching a plurality of feet to a bottom surface of the frame; and
rigidly attaching a plurality of receiver caps to a top surface of the frame;
wherein each of the plurality of feet is positioned vertically coaxial with a corresponding one of the plurality of receiver caps, such that the cable turntable device can be vertically stacked on top of a first cable turntable device and, furthermore, such that the cable turntable device can have a second cable turntable device vertically stacked on top of the cable turntable device.

20. The method of claim 12, wherein the pan is rotatably attached to the frame and/or the plate is coaxial with the pan.

21. The method of claim 12, comprising selectively controlling operation of the knob for adjusting the inner diameter of the cable turntable device by:
rotating the knob into the adjustment position to allow the pivoting movement of each of the arms relative to the corresponding one of the plurality of pivot points on the plate; and
then rotating the knob into the locking position to frictionally resist a pivoting movement of each of the arms relative to the corresponding one of the plurality of pivot points on the plate.

22. A method of simultaneously dispensing a plurality of cables from a cable turntable system, the method comprising:
providing the cable turntable system that comprises a plurality of cable turntable devices, each cable turntable device comprising:
a frame;
a pan attached to the frame;
a plate rotatably attached to the pan, wherein the plate comprises a plurality of pivot points circumferentially around and at an outer circumferential edge of the plate;
a plurality of arms pivotably attached to the plate, wherein each arm of the plurality of arms is attached to the plate at a corresponding one of the plurality of pivot points; and
a knob that is rotatable between a locking position, in which the knob applies a compressive force that presses the plate against the pan to frictionally resist rotation of the plate relative to the pan, and an adjustment position, in which the compressive force is lessened or eliminated to allow the plate and the pan to rotate relative to each other, which allows the plurality of arms to pivot relative to the corresponding one of the plurality of pivot points on the plate;
wherein, by rotating each arm relative to the plate, the cable turntable device can be used for installation of a cable in a form of a cable spool of any of a plurality of interior diameters and lengths;
for some or all of the cable turntable devices of the plurality of cable turntable devices, rotating each arm of the plurality of arms relative to the corresponding one of the plurality of pivot points on the plate to change an inner diameter of the some or all of the cable turntable devices;
providing each of the plurality of turntable devices with one of a plurality of cable spools, each cable spool of the plurality of cable spools comprising one of the plurality of cables, each of the plurality of cable spools having an internal diameter that is a same as, or larger than, the inner diameter of the cable turntable device with which such cable spool is associated;
vertically stacking the plurality of cable turntable devices sequentially on top of each other; and
dispensing the plurality of cables simultaneously, each cable of the plurality of cables being dispensed from a different one of the plurality of cable turntable devices of the cable turntable system;
wherein, in each of the plurality of cable turntable devices, the inner diameter is a same as, or greater than, a minimum acceptable bend diameter for the cable of the cable spool provided for such cable turntable device.

23. The method of claim 22, wherein the cable in each of the plurality of cable spools has a same or a different diameter from the cables of other cable spools of the plurality of cable spools.
